(19) United States
(12) Patent Application Publication
(10) Pub. No.: US 2015/0253992 A1
(43) Pub. Date: Sep. 10, 2015

(54) MEMORY SYSTEM AND CONTROL METHOD

(71) Applicant: Kabushiki Kaisha Toshiba, Minato-ku (JP)

(72) Inventors: Takashi ISHIGURO, Yokohama (JP); Jiafen YUAN, Yokohama (JP)

(73) Assignee: Kabushiki Kaisha Toshiba, Minato-ku (JP)

(21) Appl. No.: 14/480,832

(22) Filed: Sep. 9, 2014

Related U.S. Application Data
(60) Provisional application No. 61/950,339, filed on Mar. 10, 2014.

(51) Int. Cl. G06F 3/06

(52) U.S. Cl. CPC G06F 3/061; G06F 3/0679; G06F 3/0659; G06F 2206/1014

(57) ABSTRACT

According to one embodiment, in a memory system, the overlap checker is configured to perform a preliminary check operation that checks whether or not there is a logical address overlap between a first command and a second command. The first command is received by the host interface. The second command is received prior to the first command. The second command is an uncompleted command. The overlap checker is configured to queue a command received by the host interface in the command queue, and perform a recheck operation that checks whether or not there is a logical address overlap between a third command and a fourth command. The fourth command is received prior the third command. The fourth command is an uncompleted command. The third command includes an overlapped logical address detected by the preliminary check operation. The third command is dequeued by the command execution processing unit.

### CROSS-REFERENCE TO RELATED APPLICATIONS

This application is based upon and claims the benefit of priority from Provisional Application No. 61/950,339, filed on Mar. 10, 2014; the entire contents of which are incorporated herein by reference.

### FIELD

Embodiments described herein relate generally to a memory system and a control method.

### BACKGROUND

In a memory system such as an SSD, when processing a command received from a host by queuing the command in a command queue, it is necessary to check whether a logical address (LBA: Logical Block Address) of the command overlaps a logical address (LBA) of a preceding execution-uncompleted command.

### BRIEF DESCRIPTION OF THE DRAWINGS

FIG. 1 is a diagram illustrating the configuration of a memory system according to a first embodiment;

FIG. 2 is a flowchart illustrating the operation of the memory system according to the first embodiment;

FIG. 3 is a sequence diagram illustrating the operation of the memory system according to the first embodiment;

FIG. 4 is a sequence diagram illustrating the operation of the memory system according to the first embodiment;

FIG. 5 is a flowchart illustrating the operation of a memory system according to the second embodiment; and

FIG. 6 is a sequence diagram illustrating the operation of the memory system according to the second embodiment.

### DETAILED DESCRIPTION

In general, according to one embodiment, there is provided a memory system including a nonvolatile memory, a host interface, a command queue, a command execution processing unit, and an overlap checker. The host interface is configured to receive a command including a logical address. The command execution processing unit is configured to dequeue a plurality of commands in a queued order and bring the commands to be in an executable state. The plurality of commands is queued in the command queue. The overlap checker is configured to perform a preliminary check operation that checks whether or not there is a logical address overlap between a first command and a second command. The first command is received by the host interface. The second command is received prior to the first command. The second command is an uncompleted command. The overlap checker is configured to queue a command received by the host interface in the command queue. The overlap checker is configured to perform a recheck operation that checks whether or not there is a logical address overlap between a third command and a fourth command. The fourth command is received prior to the third command. The fourth command is an uncompleted command. The third command includes an overlapped logical address detected by the preliminary check operation. The third command is dequeued by the command execution processing unit.

Exemplary embodiments of a memory system will be explained below in detail with reference to the accompanying drawings. The present invention is not limited to the following embodiments.

### First Embodiment

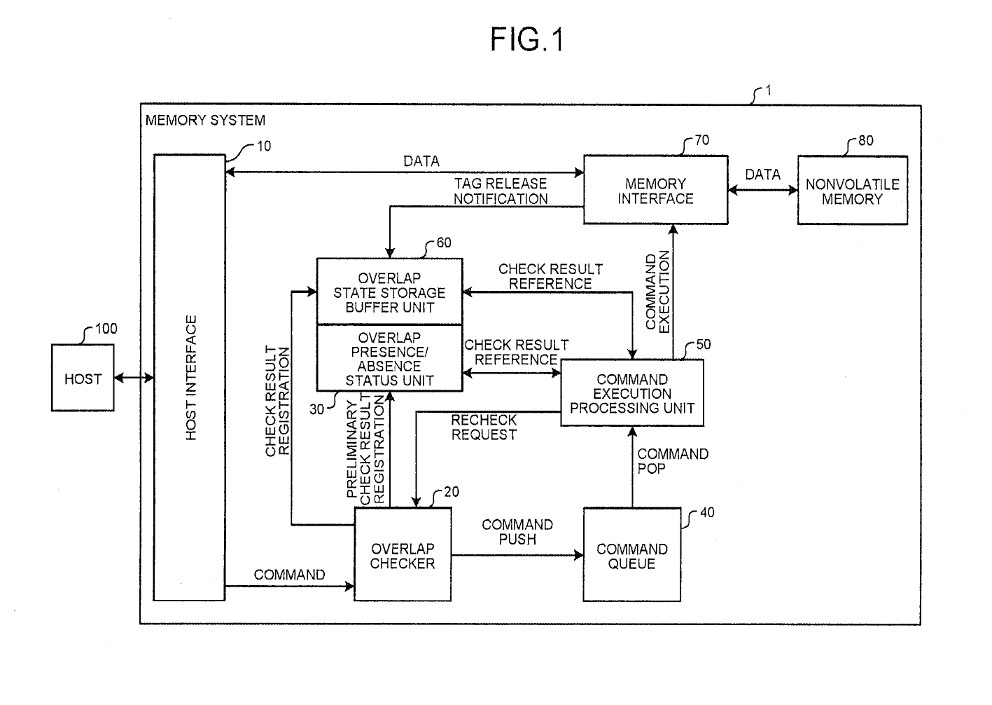

A memory system 1 according to the first embodiment will be described with reference to FIG. 1. FIG. 1 is a diagram illustrating the configuration of the memory system 1.

The memory system 1 is connected to a host 100 via a communication medium, and functions as an external storage medium for the host 100. The host 100 includes, for example, a personal computer or a CPU core.

The memory system 1 includes a storage device such as a solid state drive (SSD) and a hard disk drive (HDD). The memory system 1 is configured according to, for example, a protocol (SAS, SATA, SOP/PQT, NVMe, AHCI, and the like) which supports command queuing, and processes a command (a transfer command such as a read command and a write command of user data, for example) from the host 100.

As illustrated in FIG. 1, the memory system 1 includes a nonvolatile memory 80, a host interlace 10, a command queue 40, a command execution processing unit 50, and a memory interface 70.

The nonvolatile memory 80 is, for example, a NAND flash memory, and includes a memory cell array in which a plurality of memory cells are arrayed in a matrix. Each of the memory cells can perform multi-valued storage using upper and lower pages. In the nonvolatile memory 80, erasure of data is performed in the unit of block. Further, in the nonvolatile memory 80, internal data management by the memory interface 70 is performed in the unit of cluster, and writing and reading of data by the memory interface 70 are performed in the unit of sector. In the present embodiment, a cluster is a unit including a plurality of sectors gathered together. A sector is a minimum access unit of data from the host 100. The size of a sector is, for example, 512 B. The host 100 specifies data to be accessed by a logical address (LBA) in the unit of sector.

The host interface 10 functions as an interface between the memory system 1 and the host 100. The host interface 10 receives command data from the host 100 and transmits response notification data received from the memory interface 70 to the host 100.

In the command queue 40, a plurality of commands received in the host interface 10 are queued in the received order. Each of the commands includes a logical address for accessing a sector in the nonvolatile memory 80. The command queue 40 is a queue buffer, and the commands are dequeued in the queued order.

The command execution processing unit 50 dequeues a plurality of commands queued in the command queue 40 in the queued order in the command queue 40 to bring the commands to an executable state. More specifically, when the command execution processing unit 50 determines that a command dequeued from the command queue 40 may be brought to an executable state, the command execution processing unit 50 inputs the command to the memory interface 70 thereby to bring the command to an executable state.

A command is input to the memory interface 70 from the command execution processing unit 50. In addition, the memory interface 70 receives data from the host interface 10. The memory interface 70 executes a command input from the command execution processing unit 50. When the input command is a write command, the memory interface 70 converts a logical address included in the command to a physical address using a logical-physical conversion table (not illustrated), and writes data in the physical address. When the input command is a read command, the memory interface 70 converts a logical address included in the command to a physical address using a logical-physical conversion table (not illustrated), and reads data from the physical address.

Further, the memory interface 70 supplies response notification data to the host interface 10. When the input command is a write command, the memory interface 70 supplies write completion notification to the host interface 10. When the input command is a read command, the memory interface 70 supplies read completion notification and read data to the host interface 10.

In the memory system 1, when processing a command received from the host 100 and queued in the command queue 40, it is necessary to check whether a logical address (LBA) of the command overlaps a logical address of a preceding execution-uncompleted command. When a subsequent command whose logical address overlaps a logical address of the preceding command is executed as it is, data of a physical address chat corresponds to the logical address which is to be processed by the preceding command may be rewritten in advance, or the data of the physical address may be read before being written by the preceding command. Therefore, appropriate data may not be read and written. In order to read and write appropriate data, when there are commands whose logical addresses overlap each other, it is necessary to postpone the start of the execution of the subsequent command until processing of the preceding command is completed.

For example, when a preceding command is a write command and a subsequent command is a read command or a write command, and a logical address of the preceding command and a logical address of the subsequent command overlap each other, it is necessary to postpone the start of the execution of the subsequent command until the timing of the completion of the execution of the preceding command. In other words, it is necessary to hold the subsequent command in a standby state without bringing it to an executable state until the timing of the completion of the execution of the preceding command. Further, when a preceding command is a read command and a subsequent command is a write command, and a logical address of the preceding command and a logical address of the subsequent command overlap each other, it is necessary to postpone the start of the execution of the subsequent command until the timing of the completion of the execution of the preceding command. In other words, it is necessary to hold the subsequent command in a standby state without bringing it to an executable state until the timing of the completion of the execution of the preceding command.

It should be noted that, when the memory interface and the nonvolatile memory 80 are connected to each other through a plurality of channels, it is assumed that a plurality of preceding commands may be concurrently executed through the channels. Therefore, the number of preceding commands may be one, or may also be more than one.

In the present embodiment, as illustrated in FIG. 1, overlap check processing for logical addresses of commands is divided into a preliminary check operation before command queuing and a recheck operation at the time of dequeuing and these operations are performed separately.

As illustrated in FIG. 1, the memory system 1 includes an overlap checker 20, an overlap presence/absence status unit 30, and an overlap state storage buffer unit 60, in addition to the nonvolatile memory 80, the host interface 10, the command queue 40, the command execution processing unit 50, and the memory interface 70.

The overlap, checker 20 performs the preliminary check operation and the recheck operation. The preliminary check operation is performed before command queuing and the operation checks whether or not there is a logical address (LBA) overlap between a command that should be queued in the command queue 40 and a preceding execution-uncompleted command. The recheck operation checks whether or not there is a logical address overlap between a command that has been detected to have a logical address overlap in the preliminary check operation and dequeued by the command execution processing unit 50 and a preceding execution-uncompleted command. That is, the recheck operation is selectively performed for a command that has been detected to have a logical address overlap in the preliminary check operation, and is not performed for a command that has not been detected to have a logical address overlap in the preliminary check operation.

When the overlap checker 20 receives a command from the host interface 10, the preliminary check operation is performed for the command by the overlap checker 20. The overlap checker 20 registers the result of the preliminary check operation in the overlap presence/absence status unit 30. The result of the preliminary check operation includes information about a check target command, the information indicating the presence/absence of a logical address overlap with a preceding execution-uncompleted command (an overlap flag, for example). For example, the overlap flag indicates “overlap,” when a bit value is “1”, and indicates “no overlap” when the bit value is “0”.

The overlap presence/absence status unit 30 stores preliminary check result information therein. The preliminary check result information includes information that indicates the presence/absence of a logical address overlap with a preceding execution-uncompleted command (an overlap flag, for example) for each of a plurality of commands queued in the command queue 40. That is, the overlap presence/absence status unit 30 has the number of stages (32 stages, for example) equal to the depth of the queue of the command queue 40. Since it is only required to store information indicating the presence/absence of an overlap (an overlap flag, for example), the number of bits in each of the stages can be suppressed to approximately one bit. In other words, a capacity that corresponds to 1 bit×32 stages is sufficient as the capacity of the overlap presence/absence status unit 30. Therefore, the capacity of the overlap presence/absence status unit 30 can be reduced.

The recheck operation is performed when the command execution processing unit 50 determines, with reference to information about a dequeued command, the information indicating the presence/absence of an overlap (an overlap flag, for example) and being stored in the overlap presence/absence status unit 30, that a logical address of the dequeued command overlaps a logical address of a preceding command. When there is a logical address (LBA) overlap in the dequeued command, the command execution processing unit 50 requests the overlap checker 20 for the recheck operation. Upon receiving the request for the recheck operation from the command execution processing unit 50, the overlap checker 20 performs the recheck operation in response to the request for the recheck operation, and registers the result of the recheck operation in the overlap state storage buffer unit 60. The result of the recheck operation includes information about a check target command, specifically, information identifying a preceding execution-uncompleted command that has an overlap with the check target command (a Tag number, for example) and information indicating the presence/absence of a logical address overlap with the preceding execution-uncompleted command (an overlap flag, for example).

The overlap state storage buffer unit 60 stores recheck result information therein. The recheck result information includes information about a dequeued command, specifically, information identifying a preceding execution-uncompleted command (a Tag number, for example) and information indicating the presence/absence of a logical address overlap with the preceding execution-uncompleted command (an overlap flag, for example). That is, the overlap state storage buffer unit 60 has the number of bits (32 bits, for example) for allowing information identifying a command and information indicating the presence/absence of an overlap to he included therein. Since it is only required to prepare the number of stages for the dequeued command, the number of stages can be suppressed to approximately one stage. In other words, a capacity that corresponds to 32 bits×1 stage is sufficient as the capacity of the overlap state storage buffer unit 60. Therefore, the capacity of the overlap state storage buffer unit 60 can be reduced.

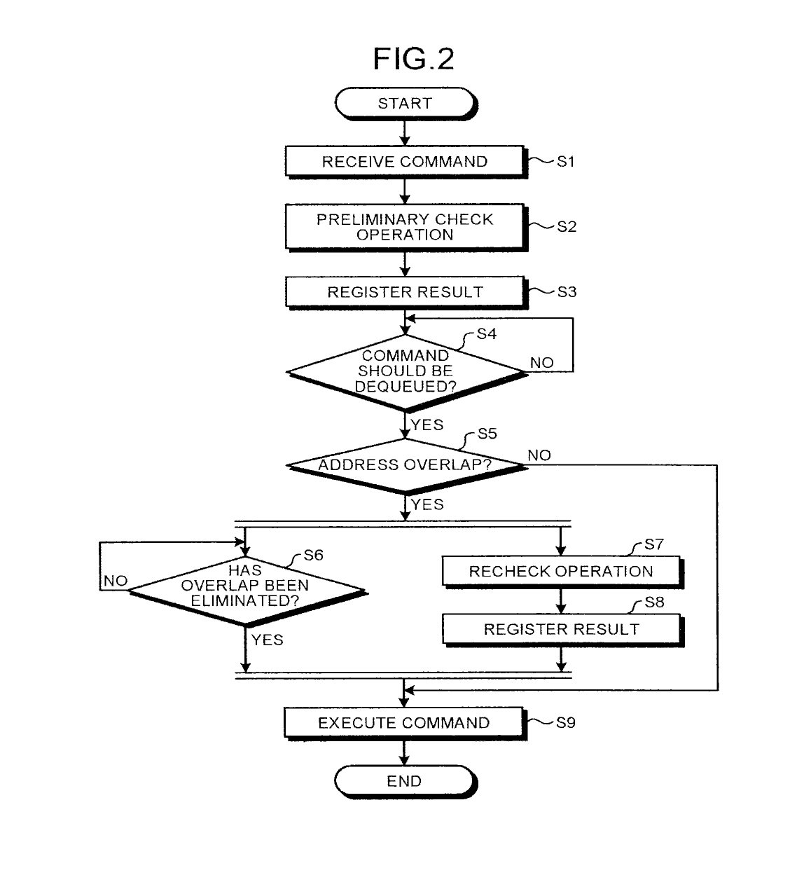

Next, the operation of the memory system 1 will be described with reference to FIG. 2. FIG. 2 is a flowchart illustrating the operation of the memory system 1. FIG. 2 illustrates the flow of the operation of the memory system 1 when focusing or one command. In the memory system processing illustrated in FIG. 2 is performed for each command.

When the host interface 10 receives a command (a transfer command such as a read command and a write command of user data, for example) from the host 100 (S1), first, the preliminary check operation for checking a logical address overlap with a preceding command is performed in the overlap checker 20 (S2). Here, the preliminary check operation indicates a check where the presence/absence of a logical address overlap between a target command and a preceding command is stored as a check result, and information about which preceding command has the overlap is not stored as the check result.

When the preliminary check operation regarding a logical address overlap is completed, the overlap checker 20 registers (stores), as a check result, information identifying the check target command (Tag number) and information, indicating the presence/absence of a logical address overlap with a preceding command (overlap flag) in the overlap presence/absence status unit 30 (S3). At this point, since the preliminary check operation is performed, information identifying a preceding command that has an overlap with the check target command (information about the Tag number) is not stored.

After the result of the preliminary check operation is registered, the command is queued in the command queue 40. The command execution processing unit 50 reads a command at the head of the command queue 40. More specifically, a command that is queued in the command queue 40 after performing the preliminary check operation moves ahead one one every time when a command at the head of the queue is dequeued (No at S4), and is dequeued therefrom after moving to the head of the queue (Yes at S4).

The command execution processing unit 50 confirms the presence/absence of a logical address overlap in the dequeued command with reference to the preliminary check result information stored in the overlap presence/absence status unit 30 (S5).

When there is no logical address (LBA) overlap (No at S5), the command execution processing unit 50 immediately inputs the command to the memory interface 70 to bring the command to an executable state. For example, the memory interface 70 reads data from the nonvolatile memory 80 and transmits the data to the host 100 via the host interface 10, or writes data received from the host 100 via the host interface 10 in the nonvolatile memory 60 (S9).

When there is a logical address (LBA) overlap (Yes at S5), the command execution processing unit 50 does not perform the dequeued command, and requests the overlap checker 20 for the recheck operation regarding the logical address overlap in the dequeued command.

Upon receiving the request for the recheck operation from the command execution processing unit 50, the overlap checker 20 performs the recheck operation in response to the request for the recheck operation (S7). Here, the recheck operation indicates a check where information about with which preceding command a target command has an LBA overlap is stored as a check result. For example, plurality of preceding execution-uncompleted commands may exist with respect to the dequeued command. Therefore, it is necessary to manage the presence/absence of an overlap and whether or not an overlap state has been eliminated for each of the preceding commands. At this point, since information identifying a command that has an overlap with a check target command is not included in the preliminary check result information registered in step S3, the overlap checker 20 performs the recheck operation to specify information identifying the command that has an overlap with the check target command in addition to the presence/absence of a logical address overlap regarding the preceding execution-uncompleted command.

When the recheck operation regarding a logical address overlap is completed, the overlap checker 20 registers (stores) the check result in the overlap state storage buffer unit 60 (S8). The overlap checker 20 registers, as the check result, information about the dequeued command, specifically, information identifying a preceding execution-uncompleted command (information about a Tag number, for example) and information indicating the presence/absence of a logical address overlap with a preceding execution-uncompleted command (overlap flag) in the overlap state storage buffer unit 60.

In parallel to the processing of S7 and S8 performed by the overlap checker 20, the command execution processing unit 50 determines whether or not an overlap between the dequeued command and one or more preceding commands has been eliminated with reference to the recheck result information stored in the overlap state storage buffer unit 60 (S6). When a bit value of “1” which indicates “overlap” is in at least one of one or more overlap flags included in the recheck result information, the command execution processing unit 50 determines that the overlap state has not been eliminated (No at S6) and returns the processing to S6.

Every time when processing of a preceding command is completed, the memory interface 70 notifies the overlap state storage buffer unit 60 of identification information (Tag number) of the completed command. The overlap state storage buffer unit 60 updates an overlap flag of the completed command in response to the notification of the completion of the execution of the command (the notification of the identification information of the completed command). More specifically, the overlap state storage buffer unit 60 rewrites the bit value of the overlap flag of the completed command from a bit value of “1” which indicates “overlap” to a bit value of “0” which indicates “no overlap”.

When all of the one or more overlap flags included in the recheck result information have a bit value of “0” which indicates “no overlap”, the command execution processing unit 50 determines that the overlap state been eliminated (Yes at S6). More specifically, the command execution processing unit 50 inputs the dequeued command held in a standby state to the memory interface 70 to bring it to an executable state when all preceding commands each of which has a logical address overlap with the dequeued command have been completed. For example, the memory interface 70 reads data from the nonvolatile memory 80 and transmits the data to the host 100 via the host interface 10, or writes data received from the host 100 via the host interface 10 in the nonvolatile memory 80 (S9).

In the configuration illustrated in FIG. 1, it is sufficient to store preliminary check result information of the number of bits equal to the depth of the queue (information indicating the presence/absence of a logical address overlap for each queued command) for the preliminary check operation and recheck result information for one command (information identifying a command that has a logical address overlap with a command to be checked+information indicating the presence/absence of an overlap) for the recheck operation. Therefore, it is enough for a buffer required for logical address overlap check processing to have a buffer size of the number of bits approximately twice the depth of the queue.

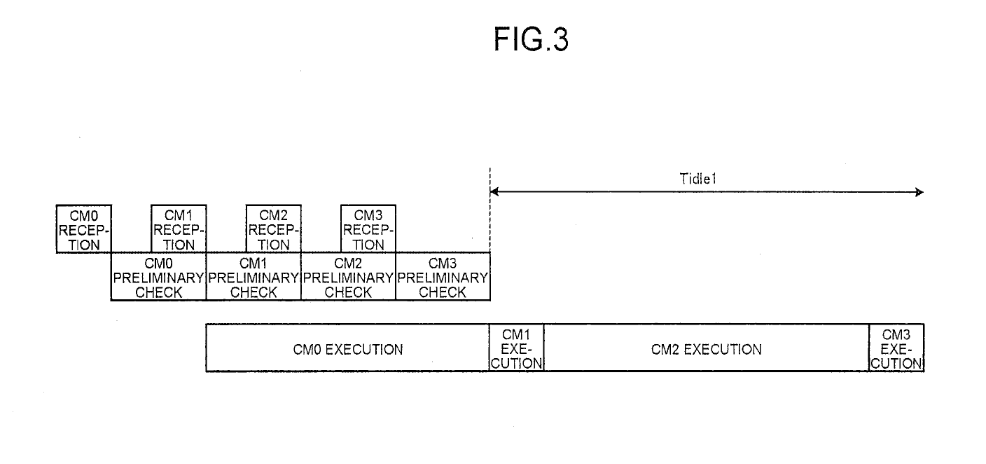

Further, by performing the preliminary check operation before command queuing, when the queue is sufficiently deep and there is no logical address (LBA) overlap, it is possible to hide overhead caused by the preliminary check operation for a logical address before executing a command as illustrated in FIG. 3. FIG. 3 is a diagram illustratively depicting processing performed for a plurality of commands CM0 to CM3 received from the host 100 with a horizontal direction as a time axis. FIG. 3 illustrates a case where there is no logical address (LBA) overlap. In FIG. 3, “CM0 reception” to “CM3 reception” correspond to S1 of FIG. 2, and indicate operations of receiving the commands CM0 to CM3 in the host interface 10. Further, “CM0 preliminary check” to “CM3 preliminary check” correspond to S2 of FIG. 2, and indicate preliminary check operations for the commands CM0 to CM3 performed in the overlap checker 20. Further, “CM0 execution” to “CM3 execution” corresponds to S9 of FIG. 2, and indicates operations of executing the commands CM0 to CM3 in the memory interface 70.

FIG. 3 illustrates a case where the commands CM0 to CM3 are sequentially received in the host interface 10, preliminary check operations are performed in the overlap checker 20 in the received order in the host interface 10, and all of results of the preliminary check operations for the commands CM0 to CM3 indicate “no overlap”. In this case, it is possible to perform the preliminary check operation for a command that has not yet gone through the preliminary check operation by the overlap checker 20 in parallel to the execution of a command that has already gone through the preliminary check operation by the memory interface 70. In the case illustrated in FIG. 3, the preliminary check operations for the commands CM1 to CM3 can be performed in parallel to the execution of the command CM0. Therefore, the commands CM0 to CM3 can be continuously executed with no overhead by the memory interface 70 without performing the recheck operation.

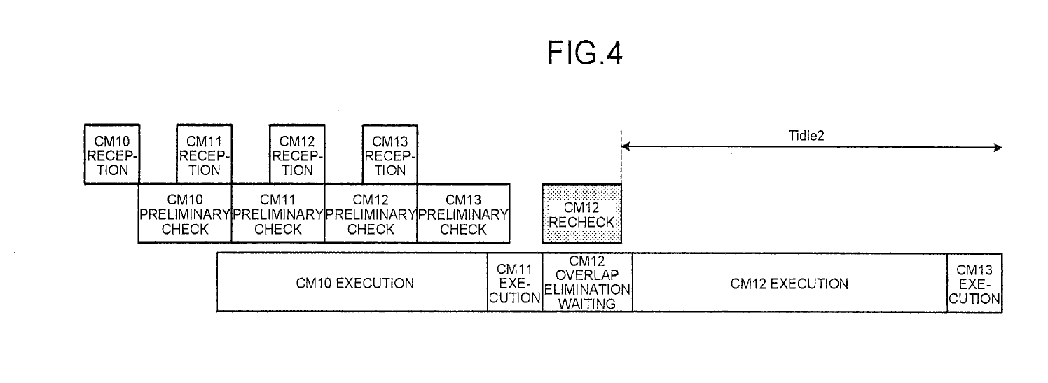

Even when a logical address (LBA) overlap occurs, as illustrated in FIG. 4, it is possible to perform the recheck operation by the time when the logical address overlap is eliminated, hide the time of performing the recheck operation, and hide overhead caused by the recheck operation at the time of dequeuing. FIG. 4 is a diagram illustratively depicting processing performed for a plurality of commands CM10 to CM13 received from the host 100 with a horizontal direction as a time axis. FIG. 4 illustrates a case where there is a logical address (LBA) overlap. In FIG. 4, “CM10 reception” to “CM13 reception” correspond to S1 of FIG. 2, and indicate operations of receiving the commands CM10 to CM13 in the host interface 10. Further, “CM10 preliminary check” to “CM13 preliminary check” correspond to S2 of FIG. 2, and indicate preliminary check operations for the commands CM10 to CM13 performed in the overlap checker 20. Further, “CM12 recheck” corresponds to S7 of FIG. 2, and indicates a recheck operation for the command CM12 performed in the overlap checker 20. Further, “CM12 overlap elimination waiting” corresponds to S6 of FIG. 2, and indicates an operation of holding the command CM12 in a standby state in the command execution processing unit 50. Further, “CM10 execution” to “CM13 execution” corresponds to S9 of FIG. 2, and indicates operations of executing the commands CH10 to CM13 in the memory interface 70.

FIG. 4 illustrates a case where the commands CM10 to CM13 are sequentially received in the host interface 10, preliminary check operations are performed in the overlap checker 20 in the received order, and the result of the preliminary check operation for the command CM12 indicates “overlap”. In this case, it is possible to perform the recheck operation for a dequeued command performed by the overlap checker 20 in parallel to the overlap elimination waiting operation of the dequeued command performed by the command execution processing unit 50. In the case illustrated in FIG. 4, the recheck operation for the command CM12 can be performed in parallel to the overlap elimination waiting operation of the command CM12. Therefore, it is possible to promptly execute a next command by the interface 70 at the timing when the overlap state is eliminated and the overlap elimination waiting operation is completed. That is, overhead in the execution of the commands CM10 to CM13 performed by the memory interface 70 can be reduced. When time required for the recheck operation is shorter than time required for executing the command, the memory interface 70 can execute a next command with no overhead.

As described above, in the first embodiment, the overlap checker 20 performs the preliminary check operation and the recheck operation in the memory system 1. The overlap checker 20 checks, as the preliminary check operation, whether or not there is a logical address overlap between a command that should be queued in the command queue 40 and a preceding execution-uncompleted command. According to the result of the preliminary check operation, the overlap checker 20 registers information about the command that should be queued, specifically, information including the presence/absence of a logical address overlap with the preceding execution-uncompleted command (overlap flag) in the overlap presence/absence status unit 30 without including information identifying the preceding execution-uncompleted command. The overlap presence/absence status unit 30 stores information including the presence/absence of a logical address overlap with a preceding execution-uncompleted command (overlap flag) for each of a plurality of commands queued in the command queue 40. Accordingly, the capacity of the buffer (the overlap presence/absence status unit 30) that is required to store the result of the preliminary check operation therein can be reduced.

Further, the overlap checker 20 checks, as the recheck operation, whether or not there is a logical address overlap between a command that has been detected to have a logical address overlap in the preliminary check operation and dequeued by the command execution processing unit 50 and a preceding execution-uncompleted command. According to the result of the recheck operation, the overlap checker 20 registers information about the dequeued command, specifically, information identifying the preceding execution-uncompleted command (Tag number) and information including the presence/absence of a logical address overlap with the preceding execution-uncompleted command (overlap flag) in the overlap state storage buffer unit 60. The overlap state storage buffer unit 60 stores information about one dequeued command, specifically, information identifying a preceding execution-uncompleted command (Tag number) and information including the presence/absence of a logical address overlap with the preceding execution-uncompleted command (overlap flag). Accordingly, the capacity of the buffer (the overlap state storage buffer unit 60) that is required to store the result of the recheck operation therein can be reduced.

Further, when the result of the preliminary check operation shows that there is no logical address (LBA) overlap, no recheck operation is required. Therefore, it is possible to continuously perform a plurality of commands with no overhead. Even when the result of the preliminary check shows that there is a logical address (LBA) overlap, since the recheck operation for a dequeued command can be performed in parallel to the overlap elimination waiting operation of the dequeued command, it is possible to promptly execute a next command at the timing when the overlap state is eliminated and the overlap elimination waiting operation is completed. When time required for the recheck operation is shorter than time required for executing the command, a next command can be executed with no overhead.

Therefore, the first embodiment makes it possible to achieve high-speed command processing while reducing the size of a buffer. In other words, both reduction in the buffer capacity that is required for registering overlap check processing result and prevention of the delay in command processing can be achieved.

### Second Embodiment

A memory system 1 according to a second embodiment will be described. In the following description, differences from the first embodiment will be mainly described.

In the first embodiment, there is idling time during which the overlap checker 20 performs no processing after the preliminary check operation for each command received in the host interface 10 is completed. For example, in the case illustrated in FIG. 3, after the completion of the preliminary check operation for the command CM3, there is idling time Tidle 1 during which the overlap checker 20 performs no processing. In the case illustrated in FIG. 4, after the completion of the recheck operation for the command CM12, there is idling time Tidle 2 during which the overlap checker 20 performs no processing.

In the second embodiment, the idling time is utilized to perform a re-preliminary check operation by an overlap checker 20. In this case, since a state of the presence/absence of a logical address overlap changes at the timing when the execution of a preceding execution-uncompleted command is completed, it would appear that it is efficient to perform the re-preliminary check operation at such timing.

Therefore, in the memory system 1, a memory interface 70 performs notification of the completion of the execution of a command (notification of the release of a Tag number) also to the overlap checker 20 in addition to an overlap state storage buffer unit 60. When the preliminary check operation for each command received in a host interface 10 is completed, the overlap checker 20 performs the re-preliminary check operation in response to notification of the completion of the execution of the command. Then, when the re-preliminary check operation is completed, the overlap checker 20 updates preliminary check result information stored in an overlap presence/absence status unit 30 according to the result of the re-preliminary check operation. More specifically, the overlap presence/absence status unit 30 rewrites a bit value of an overlap flag of the completed command from a bit value of “1” which indicates “overlap” to a bit value of “0” which indicates “no overlap”. Accordingly, it is possible to increase the number of overlap flags having a bit value of “0” which indicates “no overlap” in one or more overlap flaps in the preliminary check result information, and thereby reduce the frequency of performing the recheck operation at the time of dequeuing.

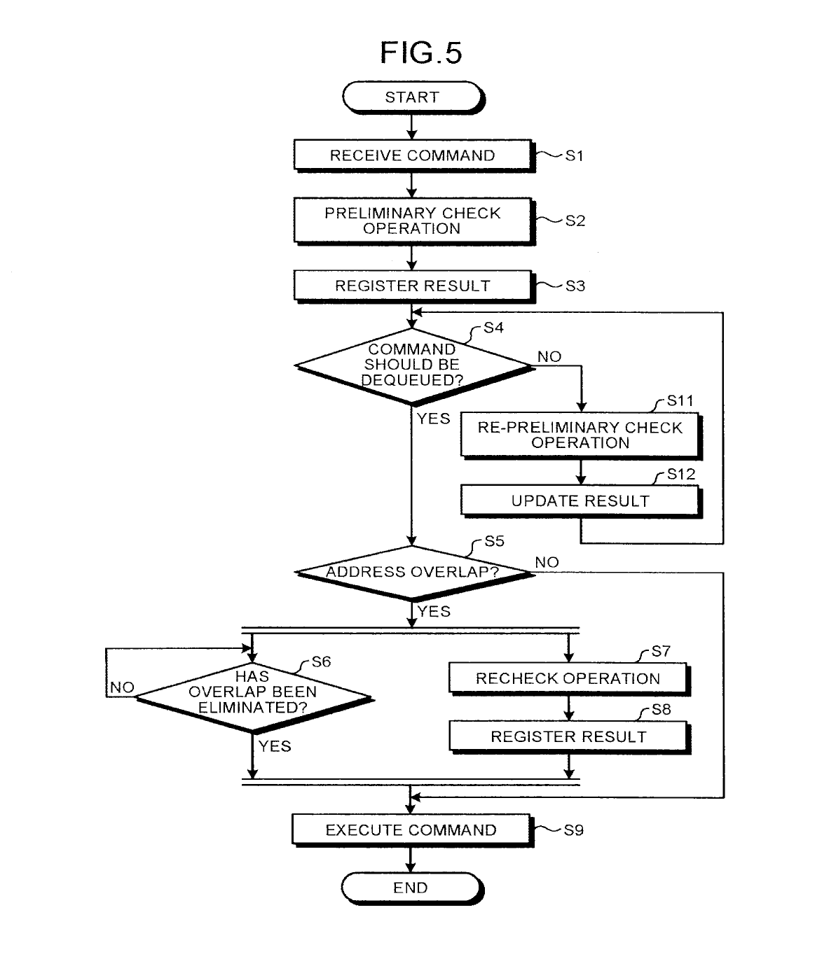

Further, as illustrated in FIG. 5, the operation of the memory system 1 is different from that in the first embodiment in the following points. FIG. 5 is a flowchart illustrating the operation of the memory system 1.

When the preliminary check operation for each command received in the host interface 10 is completed, the overlap checker 20 performs the re-preliminary check operation for a command having a logical address overlap with a preceding execution-uncompleted command in response to notification of the completion of the execution of a command (Tag release notification) (S11). More specifically, the overlap checker 20 performs the re-preliminary check operation for a command that has a bit value of “1” which indicates “overlap” in an overlap flag in the preliminary check result information with reference to the preliminary check result information stored in the overlap presence/absence status unit 30.

According to the result of the re-preliminary check operation, the overlap checker 20 updates the preliminary check result information stored in the overlap presence/absence status unit 30. For example, the overlap checker 20 rewrites a bit value of an overlap flag of the completed command in the preliminary check result information from a bit value of “1” which indicates “overlap” to a his value of “0” which indicates “no overlap” (S12).

Accordingly, by the :lime when a command that has a logical address (LBA) overlap is actually executed, the logical addresses (LBA) overlap may be eliminated, and the command may be executed without performing the recheck operation before the execution (No at S5→S9). As a result, an average command processing speed can be improved.

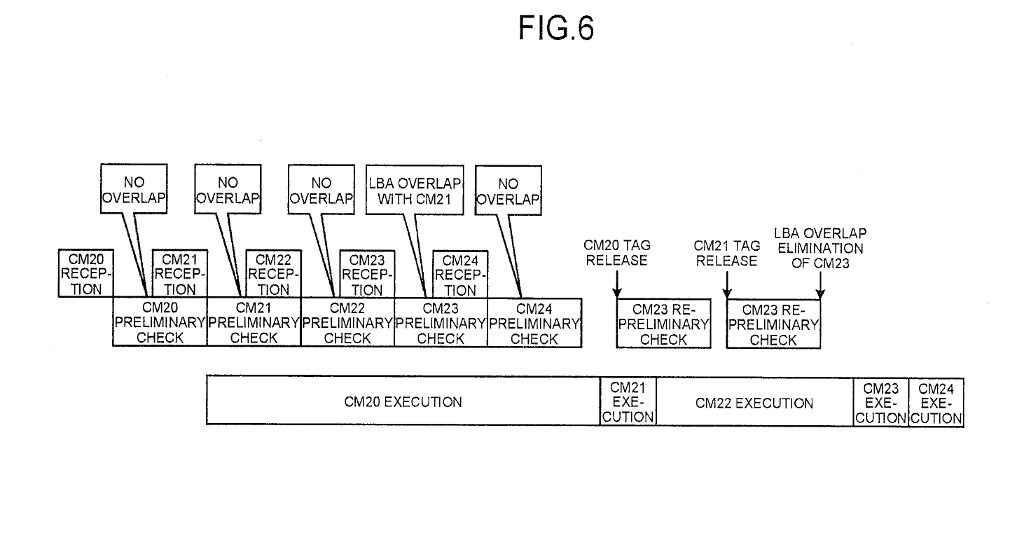

For example, as illustrated in FIG. 6, a case where commands CM20 to CM24 are sequentially received in the host interface 10, preliminary check operations are performed in the received order, and a logical address of the command CM23 overlaps a logical address of the command CM21 is assumed. FIG. 6 is a diagram illustratively depicting processing performed for the commands CM20 to CM24 received from the host 100 with a horizontal direction as a time axis. FIG. 6 illustrates a case where the logical address of the command CM23 overlaps the logical address of the command CM21. In FIG. 6, “CM20 reception” to “CM24 reception” correspond to S1 of FIG. 5, and indicate operations of receiving the commands CM20 to CM24 in the host interface 10. Further, “CM20 preliminary check” to “CM24 preliminary check” correspond to S2 and S11 of FIG. 5, and indicate preliminary check operations for the commands CM20 to CM24 performed in the overlap checker 20. Further, “CM20 execution” to “CM24 execution” corresponds to S9 of FIG. 5, and indicates operations of executing the commands CM20 to CM24 in the memory interface 70.

In the case illustrated in FIG. 6, after the completion of the preliminary check operation for the command CM24, there is no preliminary check operation occurring in response to the reception of the subsequent command. Therefore, the overlap checker 20 can perform a re-preliminary check operation during this time. More specifically, the re-preliminary of operation for the command CM23 which has a logical address overlap can be repeatedly performed every time when the completion of the execution of a command (Tag release) occurs. Accordingly, the logical address overlap of the command CM23 may be eliminated before the turn of the command CM23 to be input to the interface 70 for execution comes. In the case illustrated in FIG. 6, when a second re-preliminary check is performed, the logical address overlap of the command CM23 is eliminated. In this case, the command CM23 can be immediately input to the memory interface 70 for execution without performing the recheck operation for the command CM23.

As described above, in the second embodiment, in the memory system 1, after the completion of the preliminary check operation for each command that should be queued in the command queue 40, the overlap checker 20 performs the re-preliminary check operation for a command that has been detected to have a logical address overlap in the preliminary check result information. For example, the overlap checker 20 performs the re-preliminary check operation for a command that has been detected to have a logical address overlap in the preliminary check result information in response to notification (Tag release notification) of the completion of the execution of a command from the memory interface 70. Then, the overlap checker 20 updates the preliminary check result information stored in the overlap presence/absence status unit 30 according to the result of the re-preliminary check operation. Accordingly, the re-preliminary check operation can be repeatedly performed for a command that has been detected to have a logical address overlap in the preliminary check result information before its turn of execution comes. When the overlap is eliminated, it is not necessary to perform the recheck operation. As a result, the probability of executing a command with no waiting time during command execution start processing is increased. Therefore, it is possible to achieve higher-speed command processing.

It should be noted, when there are a plurality of commands each of which has been detected to have a logical address overlap in the preliminary check result information, the overlap checker 20 may preferentially perform the re-preliminary check operation for a command of an earlier order in the queue among the commands, or may also perform the re-preliminary check operation while selecting a command using round robin method from the commands.

Alternatively, when the overlap checker 20 recognizes the completion of the preliminary check operation for each command that should be queued in the command queue 40 without receiving notification of the completion of the execution of the command, the overlap checker 20 may continuously repeat the re-preliminary check operation for a command that has been detected to have an overlap in the preliminary check result information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory;
a host interface configured to receive a command including a logical address;
a command queue;
a command execution processing unit configured to dequeue a plurality of commands in a queued order and bring the commands to be in an executable state, the plurality of commands being queued in the command queue; and
an overlap checker configured to
perform a preliminary check operation that checks whether or not there is a logical address overlap between a first command and a second command, the first command being received by the host interface, the second command being received prior to the first command, the second command being an uncompleted command,
queue a command received by the host interface in the command queue, and
perform a recheck operation that checks whether or not there is a logical address overlap between a third command and a fourth command, the fourth command being received prior to the third command, the fourth command being an uncompleted command, the third command including an overlapped logical address detected by the preliminary check operation, the third command being dequeued by the command execution processing unit.

2. The memory system according to claim 1,
wherein the command execution processing unit brings a command dequeued from the command queue to be in the executable state, based on a result of the preliminary check operation.

3. The memory system according to claim 1, further comprising a status unit configured to store preliminary check result information therein, the preliminary check result information including a result of the preliminary check operation,
wherein the overlap checker updates the preliminary check result information.

4. The memory system according to claim 3,
wherein the command execution processing unit brings he third command to be in the executable state when no overlap in the third command is detected by the preliminary check operation, based on the preliminary check result information.

5. The memory system according to claim 3,
wherein the command execution processing unit requests the overlap checker for the recheck operation without bringing the third command to be in the executable state when an overlap in the third command is detected by the preliminary check operation, based on the preliminary check result information.

6. The memory system according to claim 5, further comprising a buffer unit configured to store recheck result information therein, the recheck result information including a result of the recheck operation,
wherein the recheck result information includes information about the third command, the information including a presence/absence of a logical address overlap with the fourth command and an identifier of the fourth command.

7. The memory system according to claim 6, further comprising a memory interface configured to execute a command input from the command execution processing unit and to notify the buffer unit of a completion of the execution of the input command,
wherein the buffer unit updates t e recheck result information, in response to the notification by the memory interface, and
the command execution processing unit brings the third command to be in the executable state when the overlap in the third command is eliminated, based on the updated recheck result information.

8. The memory system according to claim 7,
wherein the command execution processing unit determines that the overlap in the third command has been eliminated when the fourth command has a same identifier as an identifier of the third command and an execution of the fourth commands is completed.

9. The memory system according to claim 3,
wherein, when the preliminary check operation determines that the logical address overlap between the first command and the second command is exist, the overlap checker performs the preliminary check operation again and updates the preliminary check result information.

10. The memory system according to claim 9, further comprising a memory interface configured to notify the overlap checker that an execution of the second command is completed,
wherein the overlap checker performs the preliminary check operation again in response to notification by the memory interface.

11. A method of controlling a nonvolatile memory, the method comprising:
receiving a command including a logical address used to access the nonvolatile memory from a host;
performing a preliminary check operation which checks whether or not there is a logical address overlap between a received first command and a second command, the second command being received prior to the first command, the second command being an uncompleted command;
queuing a received command in a command queue;
dequeuing a plurality of commands in a queued order and bringing the plurality of commands to be in an executable state, the plurality of commands being queued in the command queue; and
performing a recheck operation which checks whether or not there is a logical address overlap between a third command and a fourth command, the fourth command being received prior to the third command, the fourth command being an uncompleted command, the third command including an overlapped logical address detected by the preliminary check operation, the third command being dequeued by the dequeuing.

12. The method according to claim 11, wherein
the bringing includes bringing a command dequeued from the command queue to be in the executable state, based on a result of the preliminary check operation.

13. The method according to claim 11, further comprising:
storing preliminary check result information in a status unit, the preliminary check result information including a result of the preliminary check operation; and
updating the preliminary check result information.

14. The method according to claim 13, wherein
the bringing includes bringing the third command to be in the executable state when no overlap in the third command is detected by the preliminary check operation, based on the preliminary check result information.

15. The method according to claim. 13, further comprising requesting the recheck operation without bringing the third command to be in the executable state when an overlap in the third command is detected by the preliminary check operation, based on the preliminary check result information.

16. The method according to claim 15, further comprising storing recheck result information in a buffer unit, the recheck result information including a result of the recheck operation,
wherein the recheck result information includes information about the third command, the information including a presence/absence of a logical address overlap with the fourth command and an identifier of the fourth command.

17. The method according to claim 16, further comprising:
executing a command to the nonvolatile memory, the command being in the executable state and notifying the buffer unit of a completion of the execution of the command; and
updating the recheck result information stored in the buffer unit in response to the notifying;
wherein the bringing includes bringing the third command to be in the executable state when the overlap in the third command is eliminated, based on the updated recheck result Information.

18. The method according to claim 17, further comprising determining that the overlap in the third command has been eliminated when the fourth command has a same identifier as an identifier of the third command and an execution of the fourth commands is completed.

19. The method according to claim 13, further comprising:
performing, when the preliminary check operation determines that the logical address overlap between the first command and the second command is exist, the preliminary check operation again; and
updating the preliminary check result information.

20. The method according to claim 19, further comprising:
notifying that an execution of the second command is completed; and
performing the preliminary check operation again in response to the notifying.
